(19) United States
(12) Patent Application Publication
(10) Pub. No.: US 2012/0206040 A1
(43) Pub. Date: Aug. 16, 2012

(54) DISCHARGE LAMP BULB

(75) Inventors: Kunio FUKAI, Shizuoka-shi (JP); Yoshiro ITO, Shizuoka-shi (JP)

(73) Assignee: KOITO MANUFACTURING CO., LTD., Tokyo (JP)

(21) Appl. No.: 13/370,520

(22) Filed: Feb. 10, 2012

(30) Foreign Application Priority Data
Feb. 15, 2011 (JP) 2011-029548

(51) Int. Cl. H01J 61/30

(52) U.S. Cl. 313/634

(57) ABSTRACT

A discharge lamp bulb has: an outer tube formed by sealing two ends of an arc tube-surrounding portion by first seal portions, the outer tube being made of quartz glass; a ceramic arc tube mounted inside the arc tube-surrounding portion; electrodes that are supported so as to be opposed to each other inside the arc tube by the second seal portion; lead wire assemblies connected to the electrodes and fixed to the first seal portions; and an electrically insulating plug that includes a metal terminal and that holds the outer tube. One of the inside lead wires is provided with a stress-relieving portion. A hollow cylindrical portion that houses the stress-relieving portion therein and that holds a periphery of the stress-relieving portion is provided integrally with the outer tube.

### INCORPORATION BY REFERENCE

The disclosure of Japanese Patent Application No. 2011-029548 filed on Feb. 15, 2011 including the specification, drawings and abstract is incorporated herein by reference in its entirety.

### BACKGROUND OF THE INVENTION

1. Field of the Invention

The invention relates to a discharge lamp bulb, in which a ceramic arc tube is integrated with an outer tube that is made of quartz glass.

2. Description of Related Art

Japanese Patent Application Publication No. 63-216262 (JP 63-216262 A) shows in FIG. 1 of JP 63-216262 A a high-pressure discharge lamp 1 (discharge lamp bulb) in which a hollow cylindrical discharge vessel 6 (ceramic arc tube) formed of an aluminum oxide ceramic is disposed inside a hollow cylindrical envelope 2 (outer tube) formed of quartz glass. Two end portions of the envelope 2 are tightly sealed by squeeze portions 3 that each have a sealing foil 5 at an inside thereof, and a discharge vessel main body 21 that constitutes the discharge vessel 6 is tightly sealed by fixing sleeves 22 to two ends of the discharge vessel main body 21 by sintering.

Inside the discharge vessel 6, electrodes (8, 18) are disposed so as to be opposed to each other. The electrodes (8, 18) are attached respectively to the sleeves 22 via tubular feeding conductors (7, 17). The discharge vessel 6 is secured and supported on the two ends of the envelope 2 via the tubular feeding conductors (7, 17), spring-shaped molded members 23, guide pins 27, feeding conductors (9, 19), and the sealing foils 5, which are continuously connected.

The discharge vessel 6 made of ceramic, when emitting light, thermally expands more greatly than the envelope 2 made of quartz glass, which is small in the coefficient of linear expansion. Therefore, the discharge vessel 6 gives a compressing force onto the feeding conductors (9, 19). However, the spring-shaped molded members 23 are disposed between the discharge vessel 6 and the feeding conductors (9, 19). Therefore, when the discharge vessel 6 thermally expands, the spring-shaped molded members 23 receive from the discharge vessel 6 compressing force in the axis direction of the guide pines 27, and therefore produce spring force in such a direction as to cancel out the compressing force. Thus, in the high-pressure discharge lamp 1 of JP 63-216262 A, the compressing force that the discharge vessel 6 gives to the feeding conductors (9, 19) due to the difference in the coefficient of linear expansion between the envelope 2 made of quartz glass and the discharge vessel 6 made of ceramic are lessened by the spring-shaped molded members 23, whereby the degradation and breakage of the feeding conductors (9, 19) are prevented.

In the ceramic discharge vessel 6 described in JP 63-216262 A, the spring-shaped molded members 23 absorb relative force that occurs in the axis direction of the guide pins 27 between the envelope 2 and the discharge vessel 6. Therefore, even when the envelope 2 vibrates in the axis direction of the guide pins 27, the discharge vessel 6 is less likely to vibrate relative to the envelope 2.

On the other hand, between the envelope 2 and the discharge vessel 6, there is not provided any means for absorbing relative force that is generated in a direction orthogonal to the axis direction of the guide pins 27. Therefore, if the envelope 2 vibrates in a direction orthogonal to the axis direction of the guide pin 27, the discharge vessel 6 vibrates in a direction orthogonal to the axis direction of the guide pins 27, relative to the envelope 2. The vibration of the discharge vessel 6 relative to the envelop 2 causes distortion in the light distribution pattern produced by the high-pressure discharge lamp 1, and is therefore not desirable.

### SUMMARY OF THE INVENTION

The invention provides a discharge lamp bulb in which it is possible to reduce the stress that thermal expansion of the ceramic arc tube integrated with an outer tube made of quartz glass occurs in lead wires and the ceramic arc tube, and in which the accuracy in positioning the ceramic arc tube relative to the outer tube is improved and the vibration resistance is improved.

A discharge lamp bulb in accordance with an aspect of the invention includes: an outer tube formed by sealing two ends of an arc tube-surrounding portion by first seal portions, the outer tube being made of quartz glass; an arc tube formed by sealing two ends thereof by second seal portions, the arc tube being made of a ceramic material and mounted inside the arc tube-surrounding portion; a pair of lead wire assemblies in each of which one end portion of a metal foil is connected to an inside lead wire, and another end portion of the metal foil is connected to an outside lead wire, wherein the pair of metal foils are integrally fixed in the first seal portions, respectively, whereby the arc tube is fixed inside the outer tube; an electrically insulating plug that includes a metal terminal to which the outside lead wire is connected, and that holds the outer tube; a pair of electrodes that are opposed to each other inside the arc tube and that are integrally and fixedly connected to the inside lead wires of the pair of lead wire assemblies, respectively; a stress-relieving portion provided in one of the inside lead wires between the second seal portion and the metal foil; and a hollow cylindrical portion that embraces the stress-relieving portion inside the hollow cylindrical portion, holds a periphery of the stress-relieving portion, and is formed integrally with the outer tube. When the ceramic arc tube thermally expands more greatly than the outer tube made of quartz glass, the stress-relieving portion reduces the stresses that occur in the ceramic arc tube and the lead wire assemblies. Besides, since the hollow cylindrical portion provided integrally with the outer tube holds the periphery of the stress-relieving portion, the stress-relieving portion is positioned in directions orthogonal to the axis direction of the outer tube. As a result, the ceramic arc tube is also positioned in the directions orthogonal to the axis direction of the outer tube, so that the ceramic arc tube improves in the accuracy of the position relative to the outer tube, and becomes less prone to vibrate in the directions orthogonal to the axis direction of the outer tube.

Hence, even though the ceramic arc tube thermally expands, the stresses that occur in the ceramic arc tube and the inside lead wires are reduced, so that the degradation and breakage of the inside lead wires will be prevented. Besides, the accuracy of the position of the ceramic arc tube relative to the outer tube improves, and the ceramic arc tube becomes less prone to vibrate in the directions orthogonal to the axis direction of the outer tube. Therefore, occurrence of distortion of the light distribution pattern is prevented, and the vibration resistance of the discharge lamp bulb improves.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an elevation of a discharge lamp bulb in accordance with a first embodiment of the invention;

FIG. 2 is a sectional view of the discharge lamp bulb of the first embodiment which is taken along the line I-I in FIG. 1, that is, taken along a center axis of an arc tube;

FIG. 3 is an enlarged sectional view showing a stress-relieving portion and its surroundings shown in FIG. 2;

FIG. 4 is a sectional view corresponding to the sectional view shown in FIG. 2, which is taken along the center axis of the arc tube of a discharge lamp bulb in accordance with a second embodiment of the invention; and

FIG. 5 is a sectional view corresponding to the sectional view shown in FIG. 2, which is taken along the center axis of the arc tube of the discharge lamp bulb in accordance with a third embodiment of the invention.

### DETAILED DESCRIPTION OF EMBODIMENTS

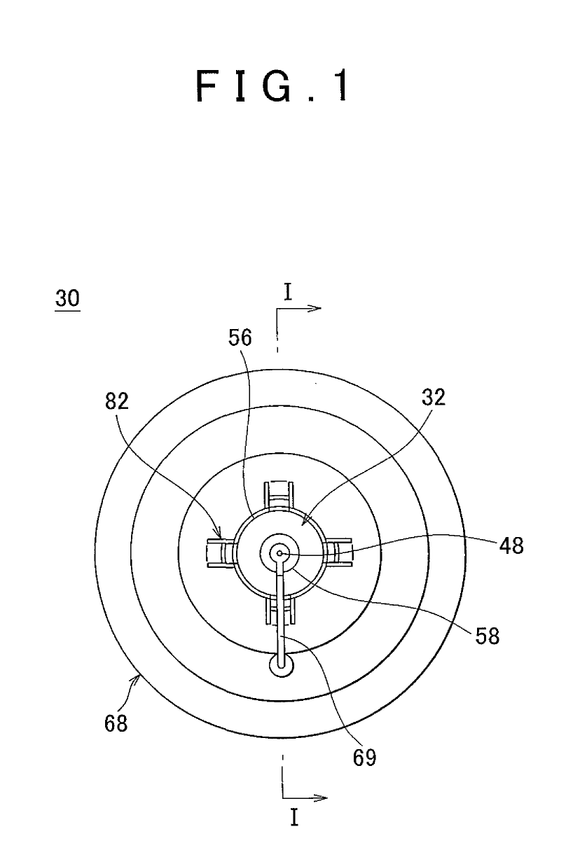

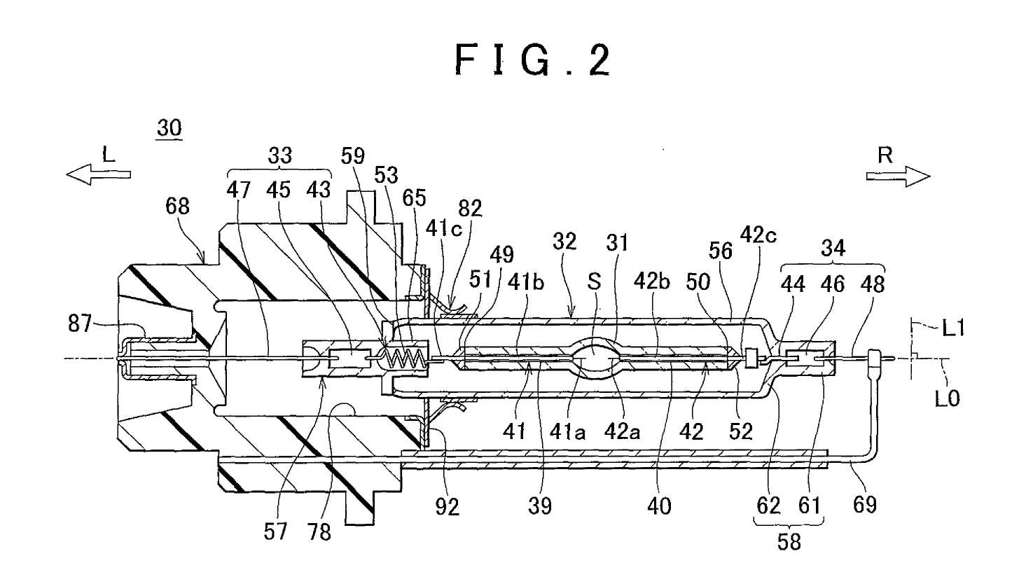

Firstly, a first embodiment of the discharge lamp bulb of the invention will be described with reference to FIGS. 1 to 3. In conjunction with FIGS. 2 to 5, an electrically insulating plug 68 side of the discharge lamp bulb along a center axis L0 is termed the left side or the proximal end side (the direction indicated by a reference character L), and a right-side first seal portion 58 side of a shroud glass tube (outer tube) 32 is termed the right side or the distal end side (the direction indicated by a reference character R).

The discharge lamp bulb 30 has an arc tube 31 made of a ceramic material, a shroud glass tube (outer tube) 32 made of quartz glass, a pair of lead wire assemblies (33, 34), and an electrically insulating plug 68.

The ceramic arc tube 31 has an arc tube main body portion that has a spheroidal shape whose center is the center axis L0 and that has inside thereof a discharge arc chamber S, and circular tube portions that are formed on two ends of the arc tube main body portion so as to be coaxial with the arc tube main body portion. Inside the circular tube portions, there are formed narrow holes (39, 40) that communicate with the discharge arc chamber S of the arc tube main body portion.

A pair of rod-shaped electrodes (41, 42) are mounted inside the arc tube 31. Each of the rod-shaped electrodes (41, 42) is formed of an electrode rod (41a, 42a) made of tungsten, a molybdenum rod (41b, 42b), and a niobium rod (41c, 42c). A proximal end side of each of the molybdenum rods (41b, 42b) is joined with a corresponding one of the niobium rods (41c, 42c). A distal end side of each of the molybdenum rods (41b, 42b) is connected to a corresponding one of the electrode rods (41a, 42a) made of tungsten.

The pair of right and left rod-shaped electrodes (41, 42) are inserted in the narrow holes (39, 40), respectively, with the electrode rods (41a, 42a) made of tungsten at their distal ends protruding into the discharge arc chamber S and opposed to each other. Besides, the niobium rods (41c, 42c) of the rod-shaped electrodes (41, 42) are greatly protruded from right and left end portions (49, 50) of the arc tube 31. The niobium rods (41c 42c) are glass-welded to right and left end portions (49, 50) of the arc tube 31, with a luminescent material enclosed inside the discharge arc chamber S. Reference characters 51 and 52 denote glass-welded portions (second seal portions). As a result, the rod-shaped electrodes (41, 42) are fixed to the arc tube 31. The discharge arc chamber S is tightly sealed, with the luminescent material enclosed inside.

Of the two lead wire assemblies (33, 34), the proximal end-side (left-side) lead wire assembly 33 is composed of an inside lead wire 43, a metal foil 45, and an outside lead wire 47. Besides, the distal end-side (right-side) lead wire assembly 34 is composed of an inside lead wire 44, a metal foil 46, and an outside lead wire 48.

The inside lead wires (43, 44), the metal foils (45, 46), and the outside lead wires (47, 47) are formed of molybdenum. In each lead wire assembly (33, 34), an end of the inside lead wire (43, 44) and an end of the outside lead wire (47, 48) are joined to the thin metal foil (45, 46) by welding or the like.

The inside lead wire 43 of the lead wire assembly 33 on the proximal end side includes a stress-relieving portion 53 that is formed of a lead wire by winding it into a coil shape, and a proximal end portion 54 and a distal end portion 55 that extend in the direction of the center axis L0 from two ends of the stress-relieving portion 53. The proximal end portion 54 is joined to the metal foil 45 by welding or the like.

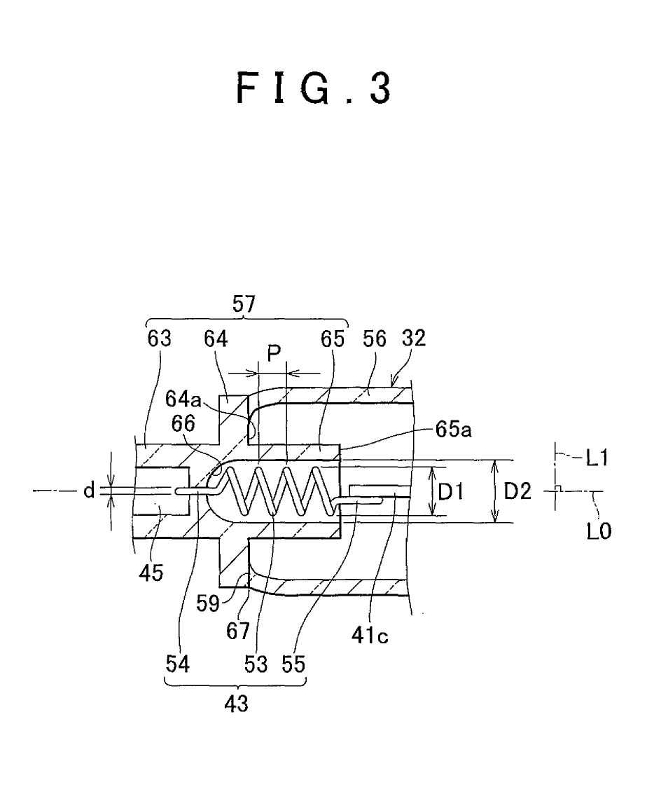

It is preferable that the inside lead wire 43 shown in FIG. 3 have a wire diameter d of d=φ0.3±0.1 mm. Besides, the coil pitch P/d of the stress-relieving portion 53 is preferably P/d=200±100% (which also applies to the inside lead wires, the outside lead wires, and the stress-relieving portions in second and third embodiments). Besides, the number of coil turns of the stress-relieving portion 53 is preferably 3 to 8. Incidentally, in the proximal end-side lead wire assembly 34, a stress-relieving portion is not provided; therefore, instead of providing the inside lead wire 44 as a separate member, the niobium rod 42c may be directly joined to the metal foil 46 by using the niobium rod 42c also as an inside lead wire (which likewise applies to the second and third embodiments).

The shroud glass tube (outer tube) 32 includes an arc tube-surrounding portion 56 that is a hollow cylinder member formed of quartz glass, and first seal portions (57, 58) formed of quartz glass.

A main body portion 63, a flange portion 64, and a hollow cylindrical portion 65 are disposed coaxially (along the center axis L0), and form the proximal end-side first seal portion 57.

The main body portion 63 is formed at the proximal end side of the hollow cylindrical portion 65 by disposing the lead wire assembly 33 inside a circular tube that forms the hollow cylindrical portion 65 and then pinch-sealing (sealing and fixing), through squeezing, a portion of the circular tube in which the metal foil 45 is disposed. As a result, the lead wire assembly 33 is integrated with the proximal end-side first seal portion 57. A proximal end portion of the hollow cylindrical portion 65 is provided with a bottom portion 66. The flange portion 64 is formed on an outer periphery of the circular tube in the vicinity of the bottom portion 66. The stress-relieving portion 53, which is a coil spring, is housed inside the hollow cylindrical portion 65, and a perimeter of the stress-relieving portion 53 is held by the hollow cylindrical portion 65. The stress-relieving portion 53, which is a coil spring, is disposed coaxially (along the center axis L0) with the hollow cylindrical portion 65.

The stress-relieving portion 53 and the hollow cylindrical portion 65 are preferably formed so that a difference between the coil outside diameter D1 of the stress-relieving portion 53 and the inside diameter D2 of the hollow cylindrical portion 65 is less than or equal to 0.5 mm (which also applies to the stress-relieving portions in the second and third embodiments). As a result, the stress-relieving portion 53 is restricted in the movement in directions orthogonal to the center axis L0 (directions indicated by an axis line L1) by the hollow cylindrical portion 65.

The distal end portion 55 continuous to the stress-relieving portion 53 is joined, by welding or the like, with the rod-shaped electrode 41 (the niobium rod 41c) that is fixed to the arc tube 31. Besides, the other rod-shaped electrode 42 (the niobium rod 42c) is joined, by welding or the like, with the inside lead wire 44 of the distal end-side lead wire assembly 34.

The distal end-side first seal portion 58 of the shroud glass tube 32 includes a main body portion 61 and a constricted portion 62 formed by constricting a distal end-side portion of the arc tube-surrounding portion 56. The main body portion 61, before the metal foil 46 is sealed and fixed, has a circular tubular shape.

The proximal end-side first seal portion 57 is integrated with the arc tube-surrounding portion 56 by disposing the arc tube 31 and the hollow cylindrical portion 65 inside the arc tube-surrounding portion 56 and then welding (indicated by reference character 67) the flange portion 64 to the proximal end portion 59 of the arc tube-surrounding portion 56. Besides, the distal end-side lead wire assembly 34 is fixed to the distal end-side first seal portion 58 by inserting the metal foil 46 inside a circular tube that forms the main body portion 61 and then squeezing an outer periphery of the circular tube for pinch sealing (sealing fixation).

As a result, the arc tube 31 is fixed inside the tightly-sealed shroud glass tube 32 via the lead wire assemblies (33, 34). Generally, the entire length of the ceramic arc tube 31 sometimes increases by about 1% due to thermal expansion. However, the arc tube 31 in accordance with each embodiment of the invention is less prone to expand relative to the glass tube 32 because the stress-relieving portion 53 cancels out the force by which thermal expansion would otherwise occur.

An end of the outside lead wire 47 is protruded out from the first seal portion 57. Incidentally, most of the stress-relieving portion 53 is disposed in a region to the right of the inner side of the flange portion 64, that is, disposed inside the arc tube-surrounding portion 56. As a result, most of the stress-relieving portion 53 is disposed at a position apart to the right in FIG. 3 from a site that is immediately radially inward of the welded portion 67, and is therefore unlikely to be affected by high temperature due to welding. Therefore, the stress-relieving portion 53, having a coil shape, is unlikely to degrade or break even if the welded portion 67 comes to have high temperature at the time of welding.

Besides, as the hollow cylindrical portion 65 is integrated with the shroud glass tube 32, the hollow cylindrical portion 65 fixes the position of the stress-relieving portion 53 in the directions indicated by the axis line L1 relative to the shroud glass tube 32. As a result, the ceramic arc tube 31 connected to the stress-relieving portion 53 is fixed in position relative to the shroud glass tube 32 in the directions indicated by the axis line L1. In consequence, the accuracy in positioning the ceramic arc tube 31 relative to the shroud glass tube 32 improves, and the arc tube 31 becomes less prone to vibrate relative to the shroud glass tube 32 in the directions indicated by the axis line L1 when the arc tube 31 is subjected to vibration. That is, in the discharge lamp bulb 30, vibration resistance improves, and deviation of light distribution pattern at the time of vibration is less likely to occur.

Incidentally, reference character 68 denotes an electrically insulating plug made of resin. The electrically insulating plug 68 has a circular cylindrical internal cylinder portion 78 that has an opening at the distal end side, and also has at its proximal end portion a metal terminal 87. The shroud glass tube 32 is fixed to a fixture portion 82 of the electrically insulating plug, with a proximal end portion of the arc tube-surrounding portion 56 inserted in the internal cylinder portion 78. The outside lead wire 47 is connected to the metal terminal 87. The outside lead wire 48 extending out from the distal end of the shroud glass tube 32 is connected to a lead support 69 made of metal which extends from the electrically insulating plug 68.

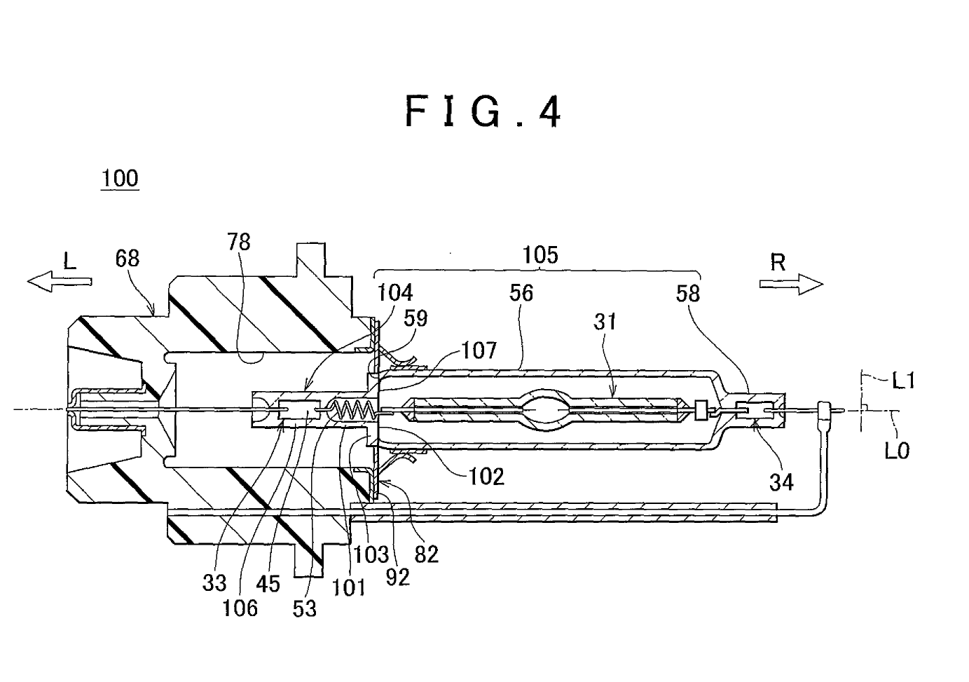

Next, with reference to FIG. 4, the second embodiment of the discharge lamp bulb of the invention will be described. A discharge lamp bulb 100 in accordance with the second embodiment has substantially the same constructions as the discharge lamp bulb 30 in accordance with the first embodiment, except that a proximal end-side first seal portion 104 of the discharge lamp bulb 100 is different from the first seal portion 57 in the first embodiment, and that the proximal end portion 59 of the arc tube-surrounding portion 56 in the second embodiment is not inserted in the internal cylinder portion 78 of the electrically insulating plug 68.

Incidentally, a shroud glass tube 105 in the second embodiment includes the arc tube-surrounding portion 56, a first seal portion 58 provided integrally with a distal end-side portion of the arc tube-surrounding portion 56, and a first seal portion 104 welded to the proximal end portion 59 of the arc tube-surrounding portion 56. The proximal end-side first seal portion 104 includes a main body portion 106, a flange portion 103, and a hollow cylindrical portion 101 that have substantially the same configurations as the main body portion 63, the flange portion 64, and the hollow cylindrical portion 65 in the first embodiment. The first seal portion 104 in the second embodiment is similar to the first seal portion 57 in the first embodiment in that a proximal end portion of the hollow cylindrical portion 101 is integrally formed with a distal end-side portion of the main body portion 106 in which the metal foil 45 is sealed and fixed. However, the flange portion 103 in the second embodiment is different from the flange portion 64 in the second embodiment in the position at which the flange portion is formed on the hollow cylindrical portion, that is, the flange portion 103 is formed on an outer periphery of a distal end portion 102 of the hollow cylindrical portion 101.

As for the hollow cylindrical portion 65 in the first embodiment, as shown in FIG. 3, a right-side end surface 65a thereof is protruded from a right-side end surface 64a of the flange portion 64 into the inside of the arc tube-surrounding portion 56. The hollow cylindrical portion 101, which houses therein the stress-relieving portion 53, in the second embodiment is different from that of the first embodiment in that, as shown in FIG. 4, the hollow cylindrical portion 101 is formed so that a distal end portion 102 of the hollow cylindrical portion 101 is flush with a distal end portion 107 of the flange portion 103, and the flange portion 103 is welded to the proximal end portion 59 of the arc tube-surrounding portion 56, so that the hollow cylindrical portion 101 is outside the arc tube-surrounding portion 56. As a result, the hollow cylindrical portion 101 in the second embodiment, unlike the corresponding portion in the first embodiment, is not protruded at all into the inside of the arc tube-surrounding portion 56.

Besides, the shroud glass tube 105 in the second embodiment, as shown in FIG. 4, is fixed to the electrically insulating plug 68 so that the proximal end portion 59 of the arc tube-surrounding portion 56 is substantially flush with a front edge portion 92 of the electrically insulating plug 68. Therefore, the shroud glass tube 105 in the second embodiment is different from the corresponding part in the first embodiment in that the shroud glass tube 105 is fixed to the electrically insulating plug 68 so that the proximal end portion 59 of the arc tube-surrounding portion 56 is not protruded into the inside of the internal cylinder portion 78 of the electrically insulating plug 68 but is disposed outside the internal cylinder portion 78.

In the discharge lamp bulb 100 of the second embodiment, since the hollow cylindrical portion 101 is not protruded into the inside of the arc tube-surrounding portion and the proximal end portion 59 of the arc tube-surrounding portion 56 is not protruded into the internal cylinder portion 78 of the electrically insulating plug 68, there is a space allowance inside the internal cylinder portion 78. Therefore, the electrically insulating plug 68 can be reduced in size, so that the discharge lamp bulb 100 of the second embodiment can be designed to be compact.

Incidentally, in the second embodiment, since most of the stress-relieving portion 53 is disposed at a position apart from the welded portion 67 to the left, the stress-relieving portion 53 is less prone to be affected by high temperature due to welding. Therefore, as for the stress-relieving portion 53 in the second embodiment, degradation and breakage are less prone to occur even when the welded portion becomes high temperature at the time of the welding, as in the first embodiment.

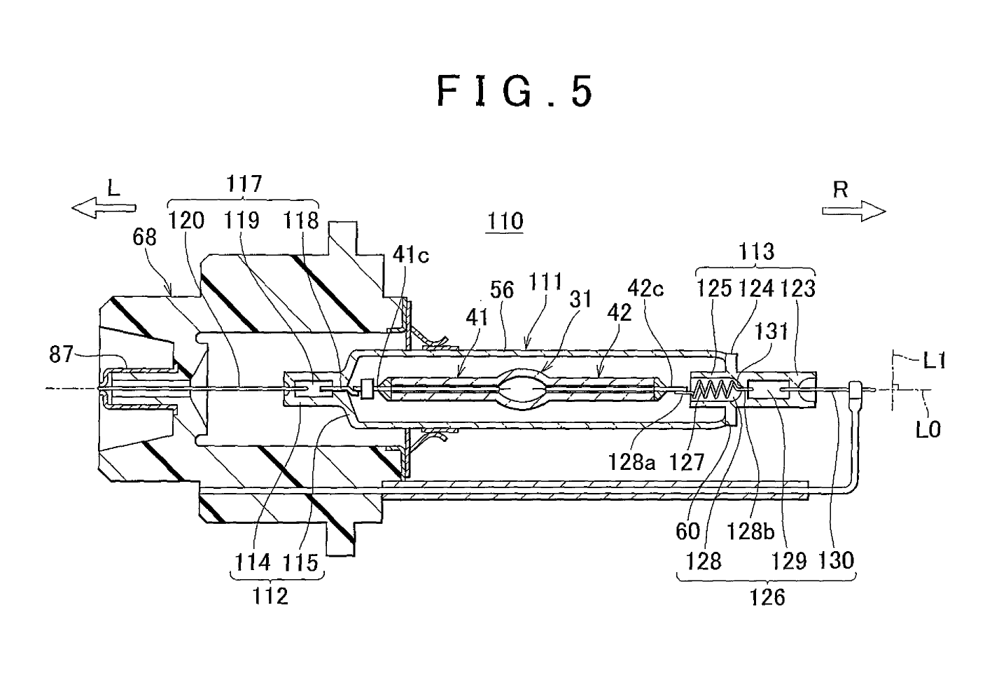

Next, with reference to FIG. 5, the third embodiment of the discharge lamp bulb of the invention will be described. A discharge lamp bulb 110 in accordance with the third embodiment has substantially the same constructions as the discharge lamp bulb 30 in accordance with the first embodiment, except that the stress-relieving portion and the hollow cylindrical portion in the third embodiment are provided not in the lead wire assembly and the first seal portion on the proximal end side but in the lead wire assembly and the first seal portion on the distal end side.

Incidentally, a shroud glass tube 111 in the third embodiment includes the arc tube-surrounding portion 56, a first seal portion 112 formed integrally with a proximal end-side portion of the arc tube-surrounding portion 56, and a first seal portion 113 welded to a distal end portion 60 of the arc tube-surrounding portion 56.

The proximal end-side first seal portion 112 includes a main body portion 114 and a constricted portion 115 provided integrally with the arc tube-surrounding portion 56, and does not have a hollow cylindrical portion. Besides, a proximal end-side lead wire assembly 117 includes an outside lead wire 120, a metal foil 119, and an inside lead wire 118 that does not have an stress-relieving portion.

The distal end-side first seal portion 113 includes a main body portion 123, a flange portion 124, and a hollow cylindrical portion 125. Besides, a distal end-side lead wire assembly 126 includes an outside lead wire 130, a metal foil 129, and an inside lead wire 128 that has a stress-relieving portion 127. The main body portion 123, the flange portion 124, and the hollow cylindrical portion 125 are disposed coaxially (along the center axis L0). Inside the main body portion 123, a metal foil 129 that is joined to the inside lead wire 128 and to the outside lead wire 130 is seal-joined (sealed and fixed).

The hollow cylindrical portion 125 is formed integrally with the main body portion 123 so that a distal end-side portion of the hollow cylindrical portion 125 is continuous to the main body portion 123. A distal end-side portion of the hollow cylindrical portion 125 is provided with a bottom portion 131. The stress-relieving portion 127 that is a coil spring is housed inside the hollow cylindrical portion 125, and a periphery of the stress-relieving portion 127 is held by the hollow cylindrical portion 125. A joint portion 128a formed continuously from the proximal end side of the stress-relieving portion 127 is joined to the niobium rod 42c of the rod-shaped electrode 42. A joint portion 128b formed continuously from the distal end side of the stress-relieving portion 127 is joined to the metal foil 129.

The flange portion 124 is formed on an outer periphery of the hollow cylindrical portion 125 in the vicinity of the bottom portion 131 which corresponds to a distal end portion of the hollow cylindrical portion 125. The flange portion 124 is welded to the distal end portion 60 of the arc tube-surrounding portion 56, with the hollow cylindrical portion 125 protruded into the inside of the arc tube-surrounding portion 56.

Inside the main body portion 114, the metal foil 119 of the lead wire assembly 117 joined to the rod-shaped electrodes 41 (the niobium rod 41c) via the inside lead wire 118 is seal-joined (sealed and fixed). The outside lead wire 120 is protruded from the first seal portion 112 to the proximal end side, and is welded to the metal terminal 87 provided in a proximal end portion of the electrically insulating plug 68. An outside lead wire 130 extending out from the first seal portion 113 is connected to the lead support 69 made of metal which extends from the electrically insulating plug 68. Most of the stress-relieving portion 127 is disposed inside the arc tube-surrounding portion 56 similarly to the stress-relieving portion 53 in the first embodiment, so that the stress-relieving portion 127 is less prone to be affected by high temperature due to the welding of the flange portion 124 to the distal end portion 60 of the arc tube-surrounding portion. Therefore, the stress-relieving portion 127 is less prone to degrade. Besides, the stress-relieving portion 127 is fixed in position in directions orthogonal to the center axis L0 by the hollow cylindrical portion 125. Therefore, the arc tube 31 is less prone to vibrate relative to the shroud glass tube 111 even when subjected to vibration. That is, in the discharge lamp bulb 110, deviation of the light distribution pattern at the time of vibration is less prone to occur, as in the cases of the first and second embodiments.

In each of the first to third embodiments, the inside lead wire may be connected to the rod-shaped electrode (niobium rod) in a state where the stress-relieving portion has been given tensile stress in the direction of the center axis L0. In that case, the compression stress that the arc tube and the inside lead wire are supposed to receive from the outer tube side as the arc tube thermally expands and extends in the direction of the center axis L0 when the discharge lamp bulb is lighted is reduced by the pre-given tensile stress. In consequence, the ceramic arc tube and the inside lead wires become less prone to degrade or break. On the other hand, the tensile stress given beforehand to the stress-relieving portion accomplishes operation of cancelling out thermal shrinkage of the ceramic arc tube that occurs after the ceramic arc tube is turned off. As a result, bending of the ceramic arc tube or the like becomes less prone to occur.

In the above-described discharge lamp bulbs, the hollow cylindrical portion may be protruded into the inside of the arc tube-surrounding portion.

An end of the arc tube-surrounding portion made of quartz glass is integrated, by welding, with one of the first seal portions that has a hollow cylindrical portion as an integrated portion. Since the hollow cylindrical portion of the first seal portion is protruded into the inside of the arc tube-surrounding portion from a location that is immediately radially inward of a site at which the first seal portion is welded to an end of the arc tube-surrounding portion, the stress-relieving portion disposed inside the hollow cylindrical portion is unlikely to be affected by high temperature due to the welding.

Hence, since the stress-relieving portion is unlikely to be affected by high temperature due to the welding operation, the stress-relieving portion does not decline in durability.

Besides, in the above-described discharge lamp bulbs, the hollow cylindrical portion may be provided outside the arc tube-surrounding portion.

If the hollow cylindrical portion is provided outside the arc tube-surrounding portion, the are tube-surrounding portion will be held by the electrically insulating plug, with the end portion of the arc tube-surrounding portion not protruded into the inside of the electrically insulating plug. As a result, since the end portion of the arc tube-surrounding portion is not protruded into the inside of the electrically insulating plug, a correspondingly large space is left inside the electrically insulating plug.

Therefore, since a corresponding space allowance is provided inside the electrically insulating plug, a discharge lamp-lighting apparatus that includes the discharge lamp bulb can be made correspondingly compact.

In the above-described discharge lamp bulbs, the hollow cylindrical portion may surround the stress-relieving portion by loosely fitting over the stress-relieving portion. In a construction in which the hollow cylindrical portion loosely fits over the stress-relieving portion, tolerances of production errors of the dimensions of various portions and the like are large, and therefore the assembly is easy.

In the above-described discharge lamp bulbs, the stress-relieving portion may have a coil shape. Such a stress-relieving portion can easily be obtained merely by forming a lead wire into a coil shape, and will achieve great effect of alleviating stress.

In the above-described discharge lamp bulbs, the inside lead wire provided with the stress-relieving portion may be connected to the metal foil in a state where the stress-relieving portion has been given tensile stress.

Since due to the stress-relieving portion, the ceramic arc tube and the inside lead wires have been given tensile stress beforehand in the direction of the center axis of the arc tube, the compression stress that the arc tube and the inside lead wire are supposed to receive from the outer tube side as the arc tube thermally expands when the discharge lamp bulb is lighted is absorbed by the pre-given tensile stress.

Hence, even though the ceramic arc tube thermally expands when the lamp bulb is lighted, compression stress is unlikely to occur in the ceramic arc tube or the inside lead wires, so that the ceramic arc tube and the inside lead wires are unlikely to degrade or break.

The invention has been described with reference to example embodiments for illustrative purposes only. It should be understood that the description is not intended to be exhaustive or to limit form of the invention and that the invention may be adapted for use in other systems and applications. The scope of the invention embraces various modifications and equivalent arrangements that may be conceived by one skilled in the art.

What is claimed is:

1. A discharge lamp bulb comprising:
an outer tube formed by sealing two ends of an arc tube-surrounding portion by first seal portions, the outer tube being made of quartz glass;
an arc tube formed by sealing two ends thereof by second seal portions, the arc tube being made of a ceramic material and mounted inside the arc tube-surrounding portion;
a pair of lead wire assemblies, in each of which one end portion of a metal foil is connected to an inside lead wire, and the other end portion of the metal foil is connected to an outside lead wire, wherein the pair of metal foils are integrally fixed in the first seal portions, respectively, whereby the arc tube is fixed inside the outer tube;
an electrically insulating plug that includes a metal terminal, to which the outside lead wire is connected, and that holds the outer tube;
a pair of electrodes that are opposed to each other inside the arc tube and that are integrally and fixedly connected to the inside lead wires of the pair of lead wire assemblies, respectively;
a stress-relieving portion provided in one of the inside lead wires between the second seal portion and the metal foil; and
a hollow cylindrical portion that embraces the stress-relieving portion inside the hollow cylindrical portion, holds a periphery of the stress-relieving portion, and is formed integrally with the outer tube.

2. The discharge lamp bulb according to claim 1, wherein the hollow cylindrical portion is protruded into an inside of the arc tube-surrounding portion.

3. The discharge lamp bulb according to claim 1, wherein the hollow cylindrical portion is provided outside the arc tube-surrounding portion.

4. The discharge lamp bulb according to claim 1, wherein the hollow cylindrical portion surrounds the periphery of the stress-relieving portion by loosely fitting over the stress-relieving portion.

5. The discharge lamp bulb according to claim 1, wherein the stress-relieving portion has a coil shape.

6. The discharge lamp bulb according to claim 5, wherein a difference between an inside diameter of the hollow cylindrical portion and an outside diameter of the stress-relieving portion is less than or equal to 0.5 mm.

7. The discharge lamp bulb according to claim 5, wherein a wire diameter of the one of the inside lead wires is within a range of 0.2 mm to 0.4 mm.

8. The discharge lamp bulb according to claim 7, wherein a ratio of a coil pitch of the coil shape to the wire diameter of the one of the inside lead wires is within a range of 1 to 3.

9. The discharge lamp bulb according to claim 1, wherein the one of the inside lead wires is connected to the metal foil, with the stress-relieving portion given a tensile stress.

10. The discharge lamp bulb according to claim 1, wherein
the electrically insulating plug is placed at one end of the discharge lamp bulb in a longitudinal direction thereof, and
the one of the inside lead wires that is provided with the stress-relieving portion is one of the inside lead wires that is positioned on a side close to the electrically insulating plug.

11. The discharge lamp bulb according to claim 1, wherein
the electrically insulating plug is placed at one end of the discharge lamp bulb in a longitudinal direction thereof, and
the one of the inside lead wires that is provided with the stress-relieving portion is one of the inside lead wires that is positioned on a side far from the electrically insulating plug.
